(19) United States
(12) Patent Application Publication
(10) Pub. No.: US 2008/0223184 A1
(43) Pub. Date: Sep. 18, 2008

(54) Locking pliers with offset jaws

(76) Inventor: Mark Anthony Stevens, Lexington, OH (US)

Correspondence Address: Mark Stevens, 184 Industrial Drive, Lexington, OH, 44904, US

(21) Appl. No.: 12/004,867

(22) Filed: Dec. 21, 2007

Related U.S. Application Data
(60) Provisional application No. 60/897,389, filed on Jan. 25, 2007.

(51) Int. Cl. B25B 7/14; B25B 7/02

(52) U.S. Cl. 81/319; 81/418

(57) ABSTRACT

A hand tools similar in design to the commonly known locking pliers. The present invention includes an offset in the jaw, placing them in a separate but parallel plane to the plane of both the handles. This offset provides clearance between the present invention and the installation surface of the material to be grasped; e.g. screws, bolts, nuts. By removing this interference the tool can more effectively engage the item thereby increasing the opportunity to manipulate the material. The offset also increases the ability of the operator to utilize the tools by providing clearance for the operator's hand. By providing clearance for the operator's hand the tools can both be clamped with more force and more force can be applied while manipulating the article in the jaws of the tool.

This application claims the priority of U.S. Provisional Patent No. 60/897,389 filed on Jan. 25, 2007.

### BACKGROUND OF THE INVENTION

1. Technical Field

The invention relates to an improved hand tool to be used to grasp material that requires additional manipulation. More particularly, the invention relates to such a tool having the basic design of locking pliers comprised of enhancements for grasping and manipulating items that are near flush to a large flat surface. Specifically, the invention relates to locking pliers with an jaws offset from the plane of the handles which allow the jaws to fully engage items that are near flush to flat surfaces. The offset also provides for clearance for the user's hand, allowing more controlled use of the invention.

2. Background Information

Locking pliers are well known in the art. These devices typically include two jaws that may be locked about an object. The locking is effected by forcing two handles together wherein the handles cooperate to form an over center mechanism.

There are many configurations of the well known locking pliers designed to hold a variety of items and employed across a number of markets segments. The art is sated with various self-locking adjustable pliers wrenches for gripping and locking onto objects within a rather wide size range. The innovations in such pliers are marked largely by improvements to the toggle mechanisms that permit the jaws to not only accommodate differently sized objects but also to lock onto the objects with varying degrees of force.

In many applications there is a requirement to grasp materials, such as bolt heads, that are near flush to the surface in which they are installed. The design of the current invention allows for more complete engagement of these near flush materials due to the offset removing any interference between the surrounding flat surfaces and the tool, and by providing clearance for the operator's hand to fully grasp the tool. Although the standard configuration of locking pliers can be used in this manner they possess several design deficiencies that are at least partially overcome by the present invention.

In Janson U.S. Pat. No. 7,044,032 and Wang U.S. Pat. No. 6,857,342 the articles are locking pliers of the normally accepted configuration. Although they are very capable of performing their primary function of securely grasping objects in their jaws, their design and geometry disallows easy and secure grasping of objects near flush to a large flat surface. The body of the items interferes with the surface and although the object can be grasped, the engagement between the object and the jaws is not robust.

Further, in Helms U.S. Pat. No. 3,793,914, we see pliers that do not have the locking mechanism but that are very capable of grasping items. These are also very common in the art. This configuration also has the interference issue when attempting to firmly grasp items flush to a large flat surface.

### BRIEF SUMMARY OF THE INVENTION

The present invention provides a hand tool similar to standard locking pliers comprising a connected set of jaw/handle assemblies constructed of a rigid material. The top jaw is rigidly attached to the top handle whereas the bottom jaw is connected to both the top jaw and the bottom handle through pivot connections. The bottom jaw is articulated though the movement of the bottom handle; opening the bottom handle (moving it away from the top handle) moves the bottom jaw away from the top jaw and the converse is true. The invention also employs an adjustable locking mechanism with release that allows the tool to be locked into the closed position. Both jaws include a plurality of teeth that are oriented perpendicular to the length of the invention.

The present invention can be used to grasp an item in the jaws with the tool and the jaws to be locked closed. The controlled material can then be manipulated with the invention. The design enhancement of the present invention allow for the invention to be securely attached to materials, such as bolt heads, that are near flush to the surface in which they are installed. The jaws exist in a separate parallel plane to the plane containing both handles. This offset creates a geometry that allows the tools to fully engage many near flush items that could not be adequately grasped with the common design. In the common design the body of the tool interferes with the surrounding of the material to be secured in addition to providing little clearance for the user to manipulate the handles of the tool. The present invention corrects the interference problem and the clearance issue through the offset, which has the effect of moving the handles away from the installation surface of the item.

### BRIEF DESCRIPTION OF THE SEVERAL VIEWS OF THE DRAWINGS

Preferred embodiments of the invention, illustrative of the best modes in which the applicant contemplates applying the principles, are set forth in the following description and are shown in the drawings and are particularly and distinctly pointed out and are set forth in the appended claims.

FIG. 1 is a side view of the invention, jaws and handles in the closed position,

FIG. 2 front end perspective view of invention, jaws open

FIG. 3 top view of the jaw/offset portion of the invention

FIG. 4 is a perspective view detailing the use of the invention, engaging a bolt against a flat surface, indicate turning motion; show clearance for the gripping hand

Similar numerals refer to similar parts throughout the specification.

### DETAILED DESCRIPTION OF THE INVENTION

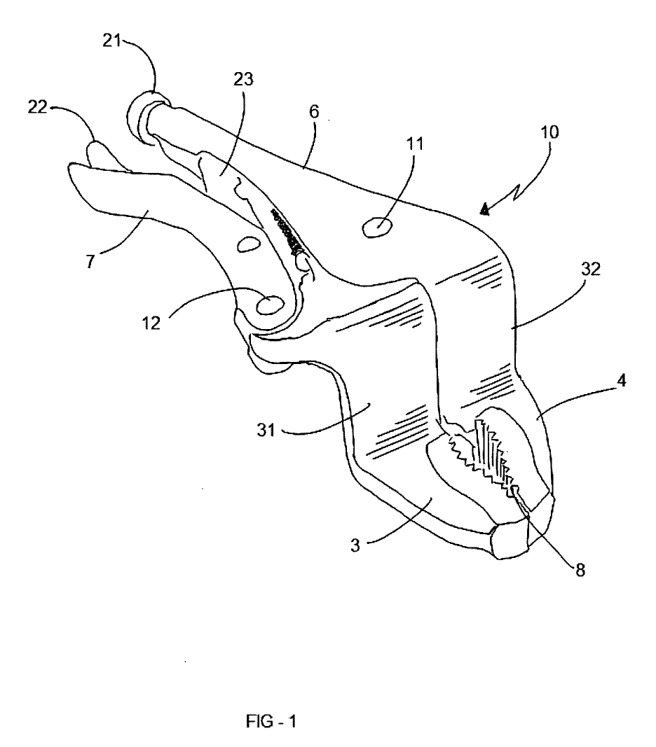

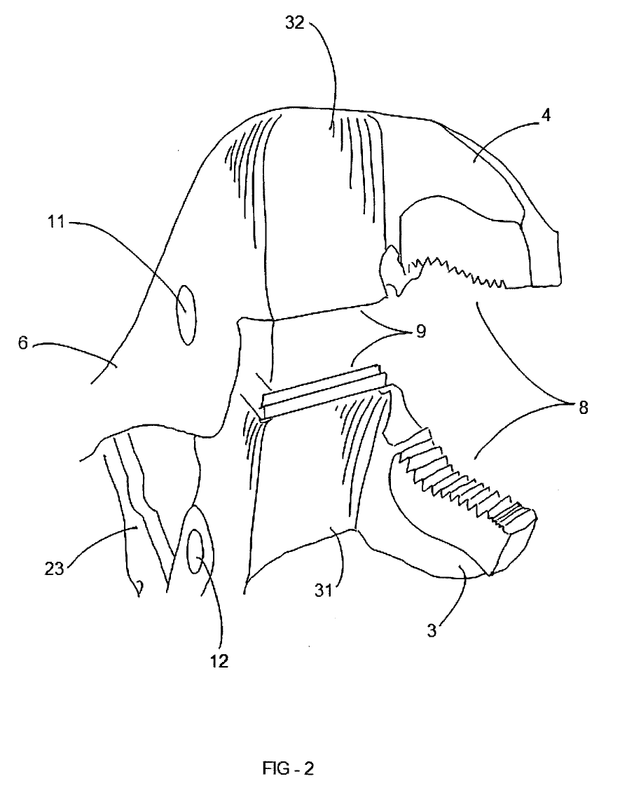

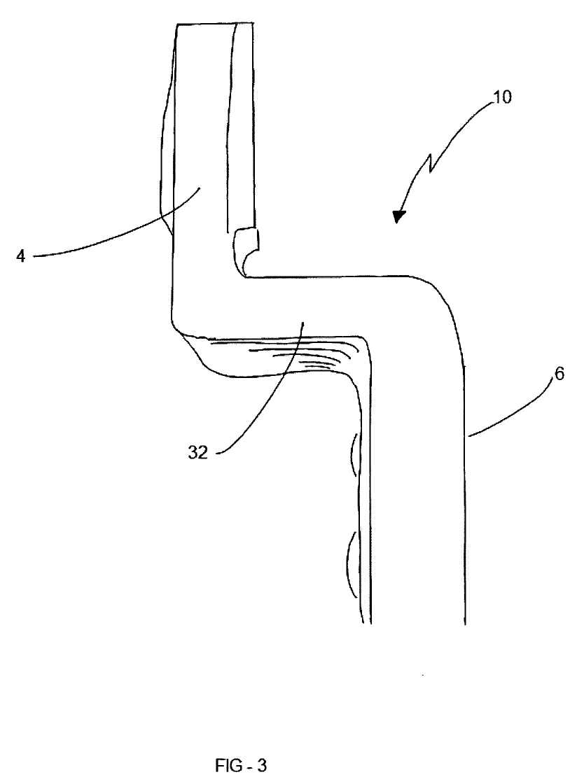

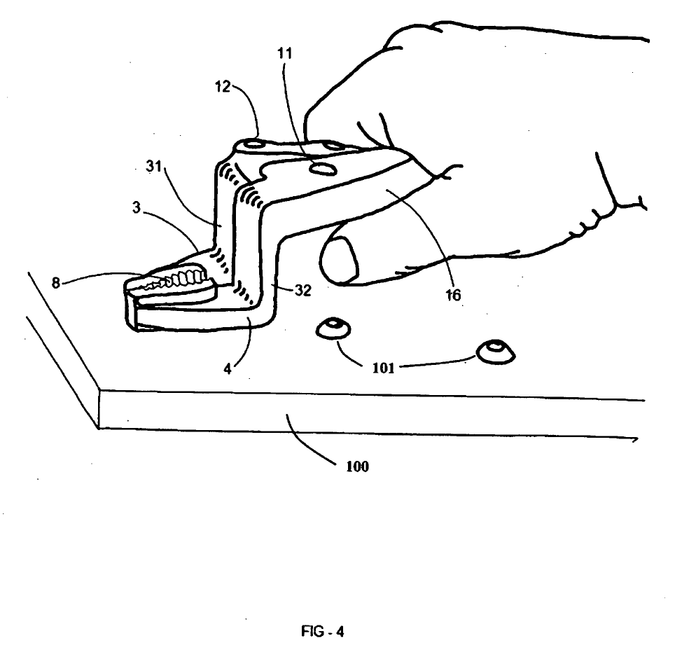

The hand tool of the present invention is indicated generally in 10 in FIG. 1. A front end view of the tools is presented in FIG. 2, giving emphasis to the offset in the jaws of the tools and the invention when in the open state. By manipulating the handles 6 and 7, FIG. 1, the jaws 3 and 4, FIGS. 1 and 2 are opened. Said tool can be used for a variety of holding/grasping operations but by its design is particularly suited to manipulate items that are flush to a large flat surface; e.g. bolt heads on a flat surface, etc. FIG. 4. This suitability is driven by the offset portions (32, 31) FIGS. 1, 2 and 3 in the jaws (4,3) FIGS. 1 and 3

The invention is comprised of two handles (6, 7) and two jaws (3, 4) seen in FIGS. 1 and 2. These are connected via pivots 11 and 12, FIG. 1 and are manipulated using a scissor-like motion. Lower handle 7 is also comprised of a lock release handle 22, FIG. 1 which is connected to 7 with a pivot and this pivot is shared with locking mechanism 22, FIG. 1. The locking mechanism, 23, of the invention is connected via pivot to lower handle 7 and is in controlled contact with upper handle 6 and locking adjustment screw 21, FIG. 1. When the invention 10 is in the closed and locked position, the tool can be opened by employing lock release 22, by moving it towards lower handle 7. By changing the adjusting screw 21 the distance between jaws 3 and 4, when the tool is closed, is altered, thereby affecting the size of the material to be grasped by the tool, FIG. 4.

The offset in the jaws of the present invention provide for improved opportunity to grasp and manipulate items that are flush to flat surface. The bolt heads 101 in FIG. 4. and the surface 100 are examples of when this is applicable. The need to turn/manipulate bolts and the like which are near flush to flat surfaces using locking pliers is a frequent occurrence. The configuration of standard locking pliers presents two problems; the first is that the geometry of the tool in relation to the surface does not allow for sufficient purchase on the item. The second is that when the tool is attached to the article the relation to the flat surface disallows full engagement of the tools with the user's hand; there simply is not clearance for the hand to fully grasp the tools. The offset of the present invention (31,32) FIG. 1 addresses both these issues. The offset is created by moving the front of jaws (3,4) into a separate but parallel plane to the plane of the handles. The offset portion of the jaws (31, 32) is perpendicular to both these parallel plans. As seen in FIG. 4, the grasping hand has clearance from surface 100 to fully engage handles (6, 7). By providing clearance for the users hand the tool can be both clamped more tightly onto the article and the user can apply more force when attempting to manipulate the grasped material. These improvements are the differences of the present invention. The inclusion of the offset has the additional benefit of providing mating surfaces 9 FIG. 2 on the offset, open/closed by the action of the jaws, that can be employed to pull wire like materials.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A pliers like hand tool comprising;
a connected set of handle/jaw assemblies constructed of a rigid material; top handle and jaw rigidly connected;
bottom jaw affixed to both the bottom handle and the top jaw with pivots;
a plurality of ridged on each jaw oriented perpendicular to the length of the invention;
an adjustable locking mechanism for securing the jaws in the closed position;
a release handle for disengaging the above mentioned locking mechanism;
an offset in the jaws placing the jaws in a different but parallel plane to both handles of the invention.
a plurality of ridges in the offset portion, perpendicular to the jaws for grasping and manipulating wire-like materials.

2. The tool in claim 1 wherein the tool, as a result of the offset in the jaws, can more fully engage near flush material like bolt heads, bearings, etc. This allows for a more secure purchase on the material and increased opportunity for the operator to manipulate the material.

3. The tool in claim 1 wherein the tool, as a result of the offset in the jaws, provides clearance for the user's hand(s) to employ the tool; removed interference between the users hand the surrounding flat surface.
